(19) United States
(12) Patent Application Publication
(10) Pub. No.: US 2014/0263674 A1
(43) Pub. Date: Sep. 18, 2014

(54) Systems, Methods, and Apparatus for Integrating Scannable Codes in Medical Devices

(71) Applicant: CONFORMIS, INC., Bedford, MA (US)

(72) Inventor: David Cerveny, Bedford, MA (US)

(73) Assignee: CONFORMIS, INC., Bedford, MA (US)

(21) Appl. No.: 14/216,874

(22) Filed: Mar. 17, 2014

Related U.S. Application Data
(60) Provisional application No. 61/792,513, filed on Mar. 15, 2013.

(51) Int. Cl. G06K 19/06

(52) U.S. Cl. CPC G06K 19/06028; G06K 19/06037
USPC 235/494

(57) ABSTRACT

Disclosed herein are apparatus, systems and methods for incorporating scannable codes into the physical structure of implants, components, parts, and surgical tools for use in various stages of the product life cycle, from patient imaging, conceptual product design, inventory management, manufacturing, shipping, surgical implantation and/or patient follow up.

### RELATED APPLICATIONS

This application claims the benefit of U.S. Provisional Application No. 61/792,513, entitled “Systems, Methods, and Apparatus for Integrating Scannable Codes in Medical Device Products” and filed Mar. 15, 2013, the disclosure of which is incorporated herein by reference in its entirety.

### TECHNICAL FIELD

The subject matter described herein relates to devices, systems and methods for using scannable one-dimensional (1D), two-dimensional (2D), or three-dimensional (3D) codes or other codes in conjunction with the design, manufacture, and use of medical implants and other devices, particularly patient-specific medical implants associated instruments. Such devices, systems and methods can include scannable codes into the physical structure of implants, components, parts, surgical tools and associated documentation to assist medical device manufacturers and other individuals in the supply chain to tracking such items and/or surgical case data throughout various parts of the product life cycle, from patient imaging, conceptual product design, inventory management, manufacturing of a product, surgical implantation and/or patient follow up.

### BACKGROUND

The design and manufacture of medical implants, particular patient-specific implants, involves the design, manufacture and assembly of devices in systems and the accurate tracking, inspection and control of the design and manufacturing process to ensure that the correct devices are manufactured within specification and provided to the intended patient. Many medical device manufacturers manufacture implants at least partially using manual assembly. Surgical implants may have multiple components and/or multiple subassemblies, and may be relatively small with complex designs that require skilled or trained assemblers to perform a variety of manufacturing process instructions (MPI) to build an implant. MPI's are usually documented on hard-copy or displayed on a computer, listing the various assembly and preparation steps including lists of various components or parts that each assembler refers to during the implant assembly. Usually, each assembler reads the steps within each MPI and takes the responsibility to collect the pertinent components or parts required to build the product. The assembler then documents these lot numbers and components on a specified form for the device master record (DMR). Once an assembler completes the assembly of an implant, the implant is generally assigned a final lot number for reference in the medical device manufacturer's DMR or for a variety of other purposes (shipping confirmation, traceability, etc). At the final stages of component assembly and/or finishing of the implant, a removable label or other code is often placed on the implant, tool or other product and associated packaging for the upcoming scheduled surgery. The shipping and receiving department can then forward the final packaged implant and tools to the surgeon with the assigned lot number and relevant instructions for use (IFU) documentation.

Errors in the manufacture, assembly, product quality, consistency and proper shipment of the final implant can occur due to human error, such as the transposition of numbers or incorrect labels. However, even in automated systems, errors are possible. Errors can also occur in systems that are complex or may have many components, subassemblies and/or custom kit pieces that create the overall manufactured product. Once the implants and the respective tools or kits are shipped to the surgeon, the surgeon may encounter issues in identifying systems and parts or even associating intended devices with the intended patients.

As a result, a need exists for improved devices, systems and methods for maintaining a high level of quality control during the design, manufacture, shipment and use of implants, instruments, and systems, especially for both patient specific and custom implants, instruments and systems.

### SUMMARY

Various devices and methods can be employed by medical device designers and manufacturers (MDM) to maintain and track implants, components, parts and surgical tools, including devices manufactured in compliance with the rules and regulations applicable in countries around the world. A wide variety of embodiments can be utilized in accordance with the various teachings described herein, including the incorporation of scannable and/or readable barcodes or other identifying indicia (including indicia for use with automated code scanning systems such as 1D, 2D or 3D barcode system—generally referred to as “code system”), or any other similar matrix or other code scanning system that can be incorporated into the design and manufacture of implants, components, parts and surgical tool and subsequently used as an optical or otherwise scannable machine-readable representation of data that contains relevant data and/or otherwise refers to the identification of objects, images, and other relevant information.

In one embodiment, a patient-specific knee implant system includes both a patient specific implant component, such as a femoral component or other component or components, and one or more patient specific cutting instruments. Each component of the system includes a scannable QR code that has been fabricated into the component during manufacture, e.g., by printing, machining or etching the QR code into a surface of the femoral component(s), which can be made, for example, of metal such as cobalt, and of the instrument(s), which can be made of a polymer material. Many combinations of such a system are possible, including, for example, additional instruments or components that are not patient specific having similar codes, as well as systems for other articular joints, such as a hip, shoulder, or ankle joint, and patient-specific systems for non-articular joints or even devices and systems that are not patient specific.

In another embodiment, a QR code is associated with, for example by printing, with any documentation associated with the device, such as a label required pursuant to regulations, an illustration of the patient's anatomy and/or device used for planning purposes (such as the iView planning illustrations manufactured by ConforMIS, Inc.), a computer generated illustration, video or simulation. Such codes can be combined alone or with components of a physical implant system to denote patient information as well as uniquely identify particular components in the system and associate them with a particular patient and/or surgery. Such codes can be used together to assist in the design process, for example, but uniquely identifying patient anatomy, medical imaging data, computer aided design models, trial implants, bone models, and other items. Such codes can be used together to assist in the manufacturing process, for example, by providing a manually or automatically scannable code to ensure the proper identity of individual components of a system, to ensure and assist in the proper and accurate inspection of individual components (such as manual and automated inspections), to ensure and assist in the complete and accurate assembly and delivery of devices and systems, and to ensure and assist in the complete and proper set up, examination, and use of such devices and systems during surgery.

Additionally, such codes can be used in some embodiments to transfer information of personal health information (PHI) or other sensitive and/or protected data in a deidentified format. For example, a QR code can be electronically generated as both a visual indicator that can be scanned and/or as a uniform resource locator that links the code to a secured web site. Thus, for example, a doctor, hospital or sales representative can receive information related to a patient-specific device or system in a graphically coded form in printed, electronic or other form, and can retrieve PHI or other sensitive or protected information over a secure network in compliance with the applicable laws of a state or country. Such information can include access to information associated with the device or system, for example, surgical planning data, manufacturing data, design information, patient information, medical images, electronic models.

In another embodiment, the MDM may design an integrated code scanning system that may include multiple scanning devices for reading identification numbers or lot numbers programed into any type of 1D, 2D or 3D codes that utilizes codes that are physically permanently integrated within the design of various implants, tools or kits provided for surgery to prevent misidentification, misassembly, mislabeling and/or erroneous shipment of implants.

In another exemplary embodiment, the integrated code system can include an inventory management system with multiple scanning devices for reading and executing inventory management applications for receiving implant components, tools, receiving kit pieces and assigning set identification numbers or lot numbers; storing such set identification numbers or lot numbers in an inventory database; consuming components, tools or fixtures and comparing consumed items to stored identification numbers or lot numbers in the inventory database; communicating missing items from inventory database, identify potentially low inventory or restocking that may become necessary, and/or identify or detect mislabeling of identification numbers or lot numbers of components associated with final implants.

In another exemplary embodiment, an integrated code system can include a patient case ordering system that incorporates one or more scanning or processing devices that can generate, embed, read and/or transmit embedded codes in conjunction with patient-specific case data information obtained during preoperative surgical work-up and storing of such data in a patient-specific database. Such codes can be embedded in or otherwise linked to electronic data files during capture of patient-specific case data information during perioperative surgery (i.e. images, notes and/or audio annotations), or can be later added to be transmitted with such data and/or can be annotated or embedded during storage in a patient-specific case data database. Such codes could also be embedded (either or both electronically and/or physically in a desired item) while reading and/or accessing of patient-specific case data information stored in a patient-specific database is accomplished, or at any point in the design, manufacturing and/or processing of the item, including testing, further analysis, modification or product improvements, inspection and quality control, etc.

In another alternative embodiment, an integrated code system can incorporate one or more scanning devices including a provider or surgeon participation management system. Such a system may assign a provider or surgeon with a readable, scannable unique identifying code (UIBC) (which may be a permanent unique identifier of the surgeon or surgical site, may be a one-time generated code that identifies the surgeon/surgical site or may be a code or key generated for each individual patient treated by the physician); may store said UIBC; may transmit patient case data associated and/or electronically embedded with the unique matrix code identification number; may allow access to such patient case data to enable the ordering of patient-specific implants, components or kits; may allow 3^{rd} party access to enable manufacturing such patient-specific implants, components, and kits with said UIBC; may facilitate the inspection, packing, shipping and receiving of such implants, tools or kits associated with such unique provider matrix code identification number; may allow the receiving entity or provider to read or scan implants, tools, or custom kits and access websites or data servers to authenticate or identify items; and/or allow authenticated surgeons or other medical personnel (as well as patients) to access websites, servers or databases to add, modify or notate the patient's file with observations, patient case data, notifications, alerts or any other data that may assist the surgeon with surgery and subsequent follow-up.

In another exemplary embodiment, the integrated code system may incorporate scanning and other devices that include a capability to confirm the prerequisite training of assemblers or technicians (prerequisite training system). The various steps associated with such prerequisite training systems could include the steps of assigning each assembler with a UIBC and storing such unique code(s) in a database; requiring training of each assembler or technician and storing completed training history associated with their UIBC; scanning a component having a UIBC prior to assembly of any manufacturing step and confirming said completed training history; allowing or denying the assembler or technician to begin or continue to assemble and/or inspect the implant; if desired, directing or redirecting such component to another qualified assembler or technician; and communicating such denial, allowance and/or other relevant information to a decision-maker or supervisor prior to assembly.

Various embodiments may include methods of integrating data traditionally contained in various locations, including in spreadsheets, server files, paper files, printed labels, packaging and marketing materials to reduce and/or prevent human errors, including manufacturing and/or shipment errors, from occurring.

It is to be understood that the features of the various embodiments described herein are not mutually exclusive and may exist in various combinations and permutations.

### BRIEF DESCRIPTION OF THE SEVERAL VIEWS OF THE DRAWINGS

FIG. 1 depicts an enlarged view of one embodiment of a linear (1D) barcode with its bars and human readable code;

FIG. 2 depicts various embodiments of linear (1D) barcodes that have low density to high density encoded characters in a given width;

FIGS. 3A-3I depict various embodiments of 2D barcodes that are currently available for use;

FIG. 4 depict the anatomy and the function of a 2D QR barcode;

FIGS. 5A-5B depict various embodiments of a 3D QR barcode and a 3D Linear Barcode that may be placed on products;

FIGS. 6A-6D depict various embodiments where a medical device manufacturer (MDM) can customize codes;

FIGS. 7A through 7C illustrate a high level block diagram of one exemplary embodiment for using 2D or 3D Matrix Codes to automate the processes of scheduling a patient surgery to delivery of products to surgeon for implantation purposes;

FIG. 8 illustrates one alternative flowchart embodiment that uses an integrated code system to enable a patient-specific product inventory management database system that facilitates and/or allows customer participation;

FIG. 9 illustrates another embodiment of a flowchart that describes an integrated code system that may be particularly well-suited for use in computer aided product design;

FIG. 10 illustrates another embodiment of a flowchart that describes an integrated code system that may be particularly well-suited for use in manufacturing operations;

FIG. 11 illustrates another embodiment of a flowchart that describes process steps that may occur after an original implant, component or kit parts did not pass QC inspection in the embodiment of FIG. 10;

FIG. 12 illustrates another embodiment of a flowchart that describes an integrated code system that may be used by the customer to track and/or store additional patient case data;

FIG. 13 depicts an exemplary set of various equipment for laser printing of a code on or into a product surface;

FIG. 14A depicts one embodiment of a laser printed barcode on/in a metal surface;

FIG. 14B depicts one embodiment of a laser printed barcode into a white, silk-screened surface to enhance readability of the barcode;

FIGS. 15A-15B depict a black and white barcode that can be dot-peened into a surface.

FIG. 16 depicts an exemplary patient-specific implant system having individual components with identifying three dimensional codes fabricated into the devices.

FIG. 17 depicts an one embodiment of a femoral implant with a 2D printed code on the non-articulating surface;

FIG. 18 depicts one embodiment of femoral implant with a 3D code placed above the non-articulating surface; and

FIG. 19 depicts one embodiment of femoral implant with a 3D code embedded or recessed into the non-articulating surface.

### DETAILED DESCRIPTION

Various devices, methods and techniques, may include the employment of a variety of processes, tools and/or devices that are suitable for use with 1D, 2D or 3D code (including barcodes, matrix codes and/or other codes readable by optical, physical, electronic and/or other sensors) by a medical implant designer and/or manufacturer. The various techniques and embodiments described herein may be particularly useful to medical device manufacturers (MDM) of a variety of implants, tools and kit systems who may be increasingly seeking a reliable, cost-effective method for identifying and tracking products through the surgical implant scheduling, the manufacturing cycle of patient-specific products, product shipment and product traceability. An autonomous, automated or semi-automated tracking system can include a permanent, machine-readable code that has been integrated and/or otherwise incorporated into various implants, components, tools and/or surgical kit pieces to uniquely identify each product. Such systems can desirably prevent shipment errors, ensure inventory management, and ensure product traceability. In various embodiments, the code will desirably be durable enough to survive a variety of manufacturing or other processes, including polishing, machining, shipping, sterilization, implantation and/or patient use, and the integrate code will desirably not adversely affect implant performance. In various embodiments, an integrated code will store sufficient information about the component and/or its intended environment of use in the limited space that may be available on implants, tools and/or surgical kit pieces.

In the following detailed description, for purposes of explanation, numerous specific details are set forth to provide a thorough understanding of the various embodiments of the disclosure. Those of ordinary skill in the art will realize that these various embodiments are illustrative only and are not intended to be limiting in any way. In addition, for clarity purposes, not all of the routine features of the embodiments described herein are shown or described. One of ordinary skill in the art would readily appreciate that in the development of any such actual implementation, numerous implementation-specific decisions may be required to achieve specific design objectives. These design objectives will vary from one implementation to another and from one developer to another.

Linear (1D) Codes

Linear barcodes were developed to enable the initial generation of automated identification technology. The linear barcode (1D) typically uses a variety of different symbologies to identify information stored and/or encoded in the barcode that typically reference additional information traditionally stored in a separate database. In various embodiments described herein, such codes could be physically embedded and/or otherwise integrated into medical products by medical device manufacturers (MDM).

FIG. 1 depicts a standard type of linear (1D) barcode 60, which includes optically readable combinations of narrow and wide bars that represent individual numbers and/or letters, and which can be combined into a code when “read” by an appropriate scanning device. Each bar and space in linear barcodes are grouped together to represent a specific ASCII character or a numeric digit. As the linear barcodes typically contain only vertical bars and spaces, the data contained therein can be stored and read only in a single (in this example, horizontal) direction, and thus such codes are typically referred as one-dimensional barcodes.

To identify the start and end of a barcode, there are special character codes 10, “guard” patterns 20, and check digits 30 that are used to indicate to the scanner where the bar code begins and ends, and also to assist with the identification of the type of symboloy used. In various commonly-used codes, the bar code can be designed to include human readable data and/or numeric strings. Usually, this human readable string is positioned at the bottom of a barcode (although other locations are possible) and such information may be used to help a human reader interpret the barcode (i.e. human readable string). The human readable string could include a manufacturer or site code 60 and a product code 40. The site code 60 may be designated as the manufacturer, a medical facility, a specific surgeon or a patient-specific code from each medical facility. The product code 40 could be designated as one portion of a multi-piece assembly in an implant, implant component, surgical instrument or jig and/or a surgical kit piece that may be required in a surgery. For example, the surgeon and medical facility could be identified with a site code of “008123.” The site code first three numbers may represent the medical facility “008;” the second set of two numbers “12,” may represent the specific doctor at the medical facility; and the last number “3” may represent the third patient that the doctor has treated at this facility. This site code 60 could allow the surgeon and medical facility to assign unique identification codes (UIC) for each patient and facilitating the employment of an automated system that can order patient-specific products from a medical device manufacturer.

As previously mentioned, various embodiments of linear barcodes 60 can include only vertical bars and white spaces, which are grouped together to represent a series of characters or digits. In such an embodiment, the linear barcodes would typically require the scanner to read the encoded characters in a given width. The scanner would send a laser beam 50 scanning the width of the code to read the information encoded in the barcode.

FIG. 2 depicts various embodiments of codes having varying information densities that could be used with the various embodiments described herein. A high density barcode 90 may include an increased variety of encoded characters in a given width (i.e. the ability to compress or otherwise encode greater amounts of data in a given width). A medium density barcode 80 could similarly have a median amount of information encoded in a given width. A low density barcode 90 would typically include less information encoded characters in a given width.

Various changes in information density in a given barcode could potentially allow a medical device manufacturer (MDM) to provide desired and/or additional data in a given string width, but the density and resolution requirements of such codes when employed as integrated codes for an implant or other component may be limited, depending on a variety of factors, including the amount of area available for a code on a given product as well as the resolution of the code made possible by a selected manufacturing method and/or technique. For example, where an extremely limited amount of space is available for a code integrated into a selected implant, the desired method of integrating the code on the implant (i.e., laser etching, machining and/or SLM manufacturing techniques) may be limited in the amount of readable data that can be created therein. The capability and preciseness of the “code writing” technique, as well as the ability of code-reading equipment to visually, physically and/or electronically “resolve” the codes, may limit the amount of information that can practically be included on a given product.

In various embodiments, it may be desirous for barcodes or other integrated code information to be used to identify revisions in an implant, to identify a specific manufacturing method or technique that was assigned to the implant (i.e. implant blank, casted implant or sintered laser metal), and may identify other kit pieces or components used in making an assembly. If desired, multiple symbologies that could potentially overlap in terms of functionality and or integration into the desired product could be employed, where each of the multiple symbologies include information relevant to a particular application, which could include machine-readable code information that cannot be comprehended by a human assembler (i.e., patient-specific identifying indicia that may be protected under Health Insurance Portability and Accountability Act rules or similar protections) in conjunction with human-comprehendible data that facilitates advancement of the product through the distribution chain (i.e., the name of a surgeon intended for use of the device, or the name of an intended surgical site).

There are a variety of other code symbologies that could be employed in the various embodiments described herein, with each level of code density, including differing flexibilities, limits on the amount of encoded character sets and information efficiencies in terms of required space and encoded data size ratio. If desired, linear barcodes may be employed as purely “numerical only” bar codes, with the potential for some additional special characters (i.e. $: +, etc) if desired. Various commercially-available numeric linear barcodes include, but are not limited to, Code 11, EAN-13, EAN-8, Industrial 2 of 5, Interleaved 2 of 5, Standard 2 of 5, UPC-A, UPC-E, HIBC (Health Care Industry Barcode), RSS, and Bookland. If desired, a numerical code could be integrated into the manufacture of various implants, products, parts, tools, fixtures and/or equipment that may be inventoried or tracked in a logistical system. If desired, a linear, 1D code containing information could, when scanned, direct the user to relevant data stored in a local, central or networked database leading to retrieval of a greater amount of information about the item scanned, such as an inventory database management system or a device manufacturing record database system (DMR) that is commonly used in medical device manufacturing.

Another type of code that may be useful in various the embodiments described herein for MDMs could be an “alphanumerical” linear code symbology. The alphanumerical data may include combinations of letters, numbers and some special characters (i.e. $: +, etc). Such examples of alphanumerical codes may be include, but are not limited to, Codebar, Code 128, Code 93, Code 39, and UCC/EAN 128 (not shown). Such codes may be particularly useful in implant manufacturing when an MDM may be interested in encoding high density numeric data that may can include product labeling and/or shipping information (i.e. postal applications) for transferring an object to medical treatment facilities. In other embodiments, a combination of alphanumeric characters may assist the manufacturer in identifying revisions of parts. MDM's may use a product code 40 (see FIG. 1) such as a mixture of letters and numbers. Such codes could allow the MDM to have the flexibility to include codes that integrate multiple combinations of product identifications for assemblies, sub-assemblies, components and kit pieces.

The use of integrated codes can provide significant advantages, including the ability to provide up-to-date information on implants and components. 1D linear barcodes allow real-time data to be collected accurately and rapidly. Various linear bar code symbologies can be used in the industry, and the integration of such systems into the initial manufacture of items can be easy transitioned into the existing design, development and manufacturing processes. Depending upon the desired use(s), various international standards may be applicable to the various codes and their uses that can further enable and improve domestic and international shipment of medical implants. The combination of barcodes or other indicia with appropriate hardware and application software creates the potential for improving performance, productivity, and ultimately profitability.

The flexibility of the use of linear barcodes in conjunction with the various systems described herein can be demonstrated by the wide variety and applicability of available code scanner systems. Various scanners can be used in mobile applications (apps) such as Google's mobile Android operating system via Google “Goggles” application or 3rd party barcode scanners like Scan or Nokia's Symbian operating system features a barcode scanner. In the Apple iOS, a barcode reader is not currently natively included, but more than fifty paid and free apps are commercially available from the iPhone store with both scanning capabilities and hard-linking to URLs. With BlackBerry devices, the App World application can natively scan barcodes and load any recognized Web URLs on the device's Web browser. Windows Phone 7.5 is able to scan barcodes through the Bing search app.

One potential limitation of the use of linear barcodes in various embodiments can include the limited data such codes can store, and such codes may not be useful to retrieve remotely-stored data if the code is erased, damaged or otherwise defaced or communications access to the remote database is not available. Linear or 1D barcodes typically store a limited amount of data, often only 12 to 20 characters. Such codes are typically scanned and used as a reference to identify entries in an external database. Moreover, when the barcode label is damaged or poorly printed, it may be difficult to identify and retrieve data. In addition, mistakes in one or more characters of a barcode, or even the addition of a single extra line at the start or end of barcode, can impair the readability and/or usefulness of the linear barcode. In some cases, even a small tear or drawing a line through the barcode parallel to the bars can disturb the decoding algorithm that makes it difficult to retrieve or read data.

2D Codes

Two-dimensional (2D) barcodes are another type of code or indicia that may be used in conjunction with various embodiments described herein, including in the medical device manufacturing processes. FIG. 3A through 3I shows various types of 2D codes that exist commercially, including, but not limited to, Data Matrix 100 (FIG. 3A), QR Code 110 (FIG. 3B), Quickmark 120 (FIG. 3C), Beetagg 130 (FIG. 3D), Microsoft Tag 140 (FIG. 3E), Trillcode 150 (FIG. 3F), Aztec 160 (FIG. 3G), Shotcode 170 (FIG. 3H), and Portable Data File (PDF) 417 180 (FIG. 3I). A common feature of these various 2D codes is that the code can be created using a pattern of black blocks and white spaces, and a scanner can capture both the entire width and length of the barcode to decode the data. The additional data dimension allows a significantly larger amount of data to be encoded as compared to linear, or 1D barcodes.

In various embodiments, a MDM may elect to integrate 2D barcode information into designed and/or manufactured items that may be in a matrix or stacked formation. One embodiment of a 2D barcode that could be used by an MDM is a data matrix code 100 as shown in FIG. 3A. Such matrix codes are typically formed of a pattern of cells that can be square, hexagonal, circular or other geometric form in shape (i.e. Data matrix 100). Data Matrix barcodes can encode all 128 ASCII characters and a number of different character sets. Such codes can have a border with two solid edges and two dashed edges, black and white cells inside, and a perimeter quiet zone. A data matrix code 100 can accommodate up to 500 MB per square inch with a data capacity of 1 to 2335 characters. Such codes are capable of retaining data with a high degree of redundancy and can significantly resist the effects of printing defects. In various embodiments, data Matrix barcodes 100 can be integrated into small items or products because they are such compact, high-density codes. The symbology contained in such codes can allow users to store information such as manufacturer, part number, lot number, and serial number on virtually any component, subassembly, or finished good. These features designed in a data matrix barcode 100 may be advantageous to an MDM. The variety of shapes that such codes may assume (and the opportunity to particularize one or more codes for applicable geometry of an implant, tool or other item) may allow an MDM to orient the specific 2D code in or on an area of an implant, component, or kit pieces that have limited space.

Another exemplary embodiment of a 2D barcode that can be used in various embodiments described herein can include a Quick Response (QR) barcode 110, such as the example shown in FIG. 3B. The QR Code has become popular due to its fast readability and greater storage capacity compared to other 2D barcodes. In essence, however, QR codes are very similar to other Data matrix barcodes in their construction and/or functionality. Both data matrix barcodes and QR codes hold significantly more information than one-dimensional barcodes, though data matrix barcodes differ from QR codes in the amount of data that may be stored in them—a data matrix barcode can hold up to 2,335 alphanumeric characters, while a similarly-sized QR code can hold up to 4,296 alphanumeric characters (see Table 1).

The QR code typically includes square black modules (square dots) arranged in a square grid on a white background. The information encoded in such codes can include one or more of four standardized data types (numeric, alphanumeric, byte/binary, Kanji) or, through supported extensions, virtually any type of data (see Table 1). To read such a code, an image sensor/scanner optically detects the 2D digital image of the code, and the data is then digitally analyzed by a programmed processor. The processor locates the three distinctive squares 190 at the corners of the image, and uses a smaller square 200 near the fourth corner to normalize the image for size, orientation, and angle of viewing (as shown in FIG. 4). The small dots can then be converted to binary numbers and their validity checked with an error-correcting code.

TABLE 1
Storage Capacity for Different Datatypes

| | Max. | | Possible Characters, |
|---|---|---|---|
| Input mode | Characters | Bits/Char | default encoding |
| Numeric only | 7,089 | 3⅓ | 0, 1, 2, 3, 4, 5, 6, 7, 8, 9 |
| Alphanumeric | 4,296 | 5½ | 0-9, A-Z (upper-case only), |
| | | | space, $, %, *, +, -, ., /, : |
| Binary/byte | 2,953 | 8 | As indicated in ISO 8859-1 |
| Kanji/kana | 1,817 | 13 | Shift JIS X 0208 |

QR code system physical integration into items can be particularly useful for MDMs in a variety of ways, including for tracking components in assembly manufacturing, product/loyalty marketing (i.e., mobile couponing where a company's discounted and percent discount can be captured using a QR code decoder in a mobile app), storing a company's information such as address and related information (alongside its alpha-numeric text data), inventory product labeling, storing personal demographic information, storing financial account information, and/or storing Uniform Resource Locators (URLs), or almost any data where users might need or desire information about the item or its intended environment of use.

In various embodiments, a QR code integrated into an item could be utilized as a “physical key” to allow MDMs to provide “secure” access for relevant personnel and/or digital equipment who directly scan the item, and then utilize the information contained therein to read browser history, read/write local storage, provide networked access to data, read/write contact data, track items using GPS, and many others, without requiring an independent password for such access. Such systems could allow a surgeon or medical facility staff to actively stream any data to a remote server, provide sensitive patient data, and authenticate identity of the reader or access equipment. If desired, the MDM may choose to encrypt QR barcodes or prove additional security measures (i.e., combinations of bar codes on separate or the same items, etc.) to protect the security of relevant information.

In various embodiments, a QR code may be initially generated and/or integrated into a manufactured or designed item, and then the code given (electronically or as part of a physical item) to a surgeon to allow a surgeon to hard link or object hyperlink to a desired database or system for the provisions of different types of necessary information. This hard linking or object hyperlinking could allow the surgeon to upload data, as well as read, retrieve and/or store any relevant information the MDM wishes to provide to a given surgeon. The surgeon may be able to scan and/or otherwise enter the QR code and display text, photos, MDM contact information, patient case data information, streaming video, email, IM, connect to a wireless network for authentication or for uploading information, or open a web page in MDM's web browser, or any combinations thereof. The MDM may also enable linking of the QR to GPS or other location information (i.e., IP address information) to desirably track where a QR code has been scanned. Such systems could help identify where shipments have arrived in erroneous locations or if a shipment was stolen. The QR code GPS locator may be designed to activate when the scanner scans the QR code to retrieve relevant geographic location information using a variety of sources, which could include using GPS and/or cell tower triangulation (aGPS) or the URL encoded in the QR code itself may be associated with a location. This could be beneficial to MDMs who ship domestically or internationally to other medical facility locations.

In another embodiment adopting a QR barcode system, the MDM may design the QR code system as an interactive marketing tool for the surgeons and medical facilities for target advertising. The interactive marketing tool may apply to currently active surgeons who already purchase products from the MDM or it may include prospective surgeons who are interested in the MDM product lines. The QR code may link to Facebook and similar “like” feature, other Social networking feeds or programs, blogs, groups, or marketing websites that the MDM creates. The MDM may use the QR barcode to direct the surgeon to a website or other social media vehicle where (1) the MDM may suggest other recommended alternative products that the MDM has in its product line; (2) the MDM may suggest to the surgeon products in other joints or other types of surgeries that they perform; (3) the MDM may suggest new products that are down the research and development pipeline; and (4) the MDM may suggest interactive blog with other surgeons and medical facilities to resolve an implant or procedural issue.

In another embodiment of a QR barcode system, the MDM may allow the surgeon to have remote access to any of the patient case data tracking, inventory tracking, and manufacturing development tracking systems. The remote access may allow the surgeon to track the development time of the patient-specific implant, view/read preoperative patient case data, or make changes to pending product list order tickets (PLOT).

Another exemplary embodiment of a 2D barcode that an MDM may decide to implement in their processes could include a BeeTagg Barcode 130 as shown in FIG. 3D or a TrillCode 150 shown in FIG. 3F. The BeeTagg Barcode 130 and the TrillCode 150 are symbologies that are typically used for “mobile tagging.” Mobile tagging is a technology that allows the MDM to “tag” a physical object to link it with some internet resource. The MDM may use it primarily for extending or augmenting an object, such as remote access to patient case data systems, inventory tracking systems, manufacturing time/shipment tracking systems, directing a surgeon to a website to read an advertisement or publication, sending a SMS, sending emails, adding contacts or events into phone lists, sending forms or playing music. The MDM may also use a BeeTagg Barcode system or the TrillCode barcode system for target marketing purposes. The MDM may send an email, send a short pamphlet or a business card with a BeeTagg Barcode to connect the surgeon to read, watch videos or photos to any current product information or upcoming new products in the pipeline.

Another exemplary embodiment of a 2D barcode that could be used in various embodiments described herein is a Microsoft Barcode Tag 140, such as the exemplary code shown in FIG. 3E. Although, the Microsoft Tag incorporates many of the features that Data Matrix and QR barcodes contain, one significant advantage that a Microsoft Tag could integrate into a barcode system is its unique “code expiration” feature. The MDM may design the use of a Microsoft barcode Tag 140 for any time-based features, such as expiration dates for a product and/or product sterilization feature, or for relevant surgical training (i.e., need for “refresher” training on a product or system). Additional uses for such codes could include targeted marketing promotions, coupons or access to MDM's systems after a patient's surgery.

Another exemplary embodiment of a 2D barcode that could be used in various embodiments described herein is an Aztec Barcode 160 as shown in FIG. 3G. The unique finder pattern of Aztec barcodes on the center of the symbol allows scanning the barcode without disturbing or turning the component or part if it is faced the wrong way. This may assist with recognizing lot numbers on an implant in a variety of orientations, including if the implant is already positioned on the patient, and removal of the implant is not feasible.

Another exemplary embodiment of a 2D barcode that could be used in various embodiments described herein is a ShotCode 170 as shown in FIG. 3H. The MDM may use a shotcode differently than a data matrix or a QR code because such codes do not typically store regular data, but they rather store a look up number consisting of 40 bits of data. The look-up number can link to a server that holds information regarding a mapped URL which the reading device can connect to in order to download, read, update or review the data.

Another exemplary embodiment of a 2D barcode that could be used in various embodiments described herein is a “Portable Data File” (PDF417) 180 as shown in FIG. 3I. This type of 2D barcode is referred to as a “stacked barcode”—stacked barcodes are like a set of linear barcodes literally stacked on top of each other. PDF417 (regular, macro or micro PDF 417) barcodes can hold just about any letter, number, or character, and PDF417 barcodes can encode up to 340 characters per square inch with a maximum data capacity of 1850 text characters. Since it incorporates the characteristics of the Data Matrix and QR barcodes, one main advantage that an MDM may design a use for PDF417 180 barcodes may be for accessing large data files or linking a series of PDF417 symbols to even access a larger sets of data. The MDM may decide to print or otherwise embed a series of such barcodes on the implant, components, or kit pieces to allow the surgeon or medical facility to access one or more MDM systems simultaneously.

3D Barcodes

An MDM may decide to integrate 3D codes as described herein within their development process or manufacturing system for a variety of advantages, including where relevant implants or other items are exposed to heavy manufacturing, high temperatures, toxic solvents, a wealth of other chemicals, or if they undergo processes that an not amenable to the use of an attachable label. Where the identification of an individual part or parts is desired during the manufacturing process (rather than simply identifying the entire assembly immediately prior to shipment), an MDM may wish to use the various embodiments described herein to improve inventory and tracking management systems for a variety of reasons, including to comply with strict federal government rules. If desired, 1D, 2D and/or 3D code may be integrated into an implant, component, or kit piece as part of an initial manufacturing process (and/or can be added at any step of the process) to log, categorize, inventory and/or track an individual item as part of the manufacturing or design process. The use of such integrated codes offers a more permanent solution than an attachable (and detachable) label or sticker.

In one embodiment, a MDM may generate and/or select a 3D QR Code 220, 3D Data Matrix Code 230 or other relevant indicia or code to be manufactured, engraved, etched, embossed, pressed, printed or otherwise embedded into an individual product as shown in FIG. 5A and FIG. 5B respectively. Once the code forms part of the specified item, it can be scanned or otherwise read by relevant equipment.

In a three dimensional code, the height or depth (or various combinations thereof) of a given piece of indicia can contain additional relevant data, and a scanner will desirably be capable of recognizing relevant character data in the code by determining the height and/or depth of each individual code element. For example, in a laser scanning reader, the scanning laser light can be bounced back from the code and the characteristics of the light can be used to determine the height of a given element as a function of distance and time, allowing the character represented by the code to be interpreted. This technique works in much the same way as the white lines or spaces function in linear barcodes, but with the added advantage that the surface of the element can be used to contain standard barcode information, while the height/depth of the element could include additional data. Alternatively, the height/depth indicia could carry the primary code information, and the 2-dimensional surfaces of the code could be uniform (i.e., the item need not have contrasting colors, textures or other features on the item to contain data, as is often required with 1D and 2D codes)

In various embodiments, the type of 3D barcode imprinting and/or integration described herein can make it nearly impossible to alter or obstruct the barcode's information and can result in fewer inventory mistakes and in turn lowers operating costs of a manufacturing process. The MDM may decide to place a barcode as part of the design of the product, during a manufacturing process or applied after with a press. Desirably, the integration of a code into the item early in the design and/or manufacturing process significantly reduces the opportunity for subsequent labelling and/or processing errors to occur later in the manufacturing, finishing and shipping process, thereby significantly reducing the possibility of error in the process.

Moreover, a significant feature of codes that can be integrated into an implant or other item is that, depending upon the design and/or “depth” of the code into the object, subsequent processing of the object's surface or other features will desirably not obliterate, degrade and/or deface the code, or otherwise render the code difficult or impossible to read. For example, an implant may have been initially fabricated in a manufacturing process to certain desired dimensions, but further processing and/or machining of various implant features is desired. Such an “unfinished” implant could be embedded with a code to a depth sufficient to ensure that subsequent removal of surface or other material proximate to the embedded code will not completely obliterate or deface the code, thereby allowing for assured identification of the relevant implant even after subsequent processing and finished steps are accomplished. In one exemplary embodiment, an implant surface could be embedded with a code to a depth of 0.55 mm, and subsequent polishing and finishing of the surface could remove no more than 0.30 mm thickness of material, thereby leaving the code embedded in the surface to at least a depth of 0.25 mm which will desirably be sufficiently readable by subsequent scanning equipment.

In various embodiments, the MDM may choose to integrate a barcode system into assembly lines as part of the process. They can be used to track a part on the line to assess efficiency of the production process, or to account for the number of man hours needed to create a single part. This can help reduce underpricing products and save the company on production costs. The barcodes can, of course, still be used as an inventory system and for purchases. The parts in question can each be scanned before being placed on a truck or train and can then be verified when delivered.

If desired, product packaging could be provided that allows for direct visualization and/or scanning of relevant codes integrated on the product (i.e., through a transparent window or other feature in the packaging) which ensures direct verification that the correct applicable part is being shipped. Where 3D codes may be used, but cannot be accurately scanned due to intervening features (i.e., a transparent window that allow visualization of the code but prevents reading of indicia depth), other code types could be included as an element of the 3D code, such as two-dimensional color coded information integrated into surface features of the 3D code, to allow 2D scanning and identification of relevant code information on the item in such circumstances.

In various embodiments, an MDM may choose to integrate a barcode system on parts in an attempt to control inventory and/or to identify stolen goods. The MDM may place microscopic 3D barcodes on such items by applying or drilling an electron-beam lithograph into the plastic, metal or other material surface face of the microscopic square producing an inset surface. Then, the MDM may discreetly place the barcode within the space provided in the inset surface. This may be desirable when shipping product internationally to ensure receipt and preventing thefts.

Barcode Readers

In various embodiments, a variety or combination of 1D, 2D and/or 3D scanners can be includes in the various systems to assist designers, manufacturers, assemblers, technicians, sales personnel and/or medical personnel to identify the items where necessary or desired and perform their job requirements efficiently and effectively. An MDM may integrate various scanners into the systems described herein, including handheld devices, mobile applications, mobile computers, or systems that may be used in conjunction with independent fixed mounted cameras.

In one exemplary embodiment, the use of handheld scanners may be desired, at least partially due to the flexibility and adaptability to many uses and environments that such systems provide. A wide variety of handheld scanners can be provided that can read 1D, 2D or 3D barcodes (or combinations thereof) that the MDM may decide to implement. Handheld scanners come in a variety of shapes and sizes that are typically built to meet specific needs of manufacturers and processes (see Table 2, all of which is incorporated herein by reference). The MDM may place the same or different types of scanning devices throughout a given manufacturing process, as well as use differing types of scanners for surgeons, inspectors, sales personnel, machinists, etc. The manufacturer may design their own scanner that meets a variety of needs or select a commercially available handheld scanner, which could include any combination of the various scanners indicated in Table 2.

TABLE 2
Types of Scanners

| Scanner Type | Cost | Volume | Model |
|---|---|---|---|
| Entry Level Scanners | Least expensive, close | Low volume scanning | IDTech Econoscan II |
| | range scanning, limited | across multiple | |
| | capabilities | industries | |
| Mid-Level Scanners | Mid-range pricing, can | Medium to high volume | Symbol LS2208; |
| | read poorly printed | scanning across multiple | Honeywell Xenon 1900; |
| | barcodes, greater | industries | |
| | programming options | | |
| Professional Level | Most expensive, many | High volume scanning for | Datalogic Gryphon L |
| Scanners | are shock and | industrial environments | GD4300; |
| | contamination resistant, | | Honeywell Genesis; |
| | usually highly | | Datalogic Magellan |
| | programmable | | 1100i; |
| Industrial Scanners | Most expensive, they are | High volume scanning for | Datalogic Powerscan |
| | built with heavier duty | industrial environments | D8300; |
| | plastics and sealed | and can read incredibly | Symbol LS3578; |
| | components. | damaged or long | Symbol DS3408; |
| | | distance barcodes | Honeywell Granit 1910i |
| Scale Barcode | Most expensive, they are | High volume scanning for | Magellan 8500XT; |
| Scanners | omni-directional | multiple industries | Honeywell Stratos |
| | scanning, weighing, and | | |
| | space saving sizes | | |
| Wand Scanners | Lease expensive, they are | Low volume scanning for | Unitech MS120; |
| | shaped like a pen | multiple industries using | UniTech MS100 |
| | | documents | |
| Wireless Scanner | Most expensive, they are | Medium volume for | Motorola LI4278; |
| | a wireless scanner using | multiple industries | Honeywell Voyager |
| | Bluetooth or RF radios | | 1202 g; |
| | | | Honeywell Xenon 1900; |
| | | | Symbol DS6708 |
| | | | Bouwa BPA- |
| | | | 5000BW108; |
| Keyfob Scanners | Least expensive, small | Medium volume for | Scanfob 2002; |
| | size and uses Bluetooth | multiple industries | Koamtac KDC200; |
| | | | KeyBatch BR2 |

In various embodiments, 1D, 2D or 3D codes may be scanned and/or decoded using mobile applications on several mobile platforms, such as Google's Android OS, iphone, Windows, Nokia, Blackberry, and many others, making the use of mobile phone app scanners extremely flexible for surgeons, medical facility staff, and marketing and sales personnel, etc. A mobile scanning applications can turn a camera phone into a barcode scanner, which may be used to capture a code image, then the mobile application software can analyze the barcode, which may open an URL, start a mobile application, contact a call center, retrieve stored information, enable virtual product implant shopping or ordering, or many combination of functions that such 1D, 2D and 3D codes can provide.

For example, when a surgeon or technician may be running low in inventory of parts provided in a surgical kit, the individual may snap a photo of the 1D, 2D or 3D barcode on the part, and the mobile app could add the part number to their uniquely assigned “shopping cart” that the MDM created for the surgeon. In various embodiments, a MDM may choose to design their own mobile scanning application that may be customized with the company's Logo, contact information, IT frequently asked questions (FAQ), or other specific information that the MDM wishes available for use.

In another embodiment, the MDM may use to scan 1D, 2D or 3D barcodes using mobile computer scanners. The MDM may use a mobile computer scanner to act like a desktop or laptop computer with an operating system (i.e. Windows), application software, a keyboard and a display screen, instead of using a handheld scanner attached to a separate computer. The MDM may choose to upload the software or the specific system (i.e. inventory management system, patient case data system or ordering/tracking system) onto the mobile computer directly so that the surgeon or any other user may be able to update, make edits, while scanning on the go, and the user may not have to go back and forth to a stationary PC. The MDM may choose to program the mobile computer scanner to a store the information within the scanner (batch mode) or send the information to some type of database on a LAN (real-time) to update any system rapidly. These programmable choices in a mobile computer scanner allows an MDM to be flexible under high-speed processes, or places where batch storing is necessary when building in a clean room environment. Choosing either method of data storage allows for fast and accurate data entry for the MDM. In addition, alternative embodiments of mobile computer scanners may include WiFi, 3G or 4G network options, or Bluetooth capabilities to increase mobility of assemblers, sales persons, or surgeons. Also, the MDM may wish to have a GPS, a regular camera, a phone and color screens to make the accessory surgeon-friendly. Such a system could allow the surgeon or any user to have the ability to make voice calls, send text messages, and use the internet on the 3G network for added convenience of a PC while being completely mobile. Such a system could also enable to physician to seek “real time” consultation with an implant engineer or designer during a surgical implantation procedure.

In another embodiment, the MDM may choose to use a fixed or mounted scanner in their internal processes where no operator is required to assist the “scanning” function. There are many types of fixed or mounted scanners that the MDM can select from, such as straight line, fixed raster line, raster line, X pattern, omnidirectional (multi-line) or omnidirectional (star pattern). Any of these types of scanners may be used by an MDM because they allow a hands-free solution to scan—the fixed mounted scanners can be positioned so that all integrated codes passing by will appear in the “read window.” Once the code passes the “read window” the scanner is capable of reading any type of 1D, 2D or 3D barcode. The “read” window can be defined by the scanner's scan width, focal distance, and depth of field. This is especially desirable in a clean room environment or in an Operating Room where cleanliness and sterility is of highest importance. In an alternative embodiment, the MDM may choose to program the fixed or mounted scanner with automatic barcode detection, sensory or object detection, a hand operated trigger, or a combination thereof. As with other types of scanners, the fixed mounted scanner recognizes the barcode and the sends the information to a host computer or other remote location.

1D, 2D or 3D Barcode Customization

FIGS. 6A-6D depict various embodiments in which 1D, 2D or 3D codes include customized logo information. If desired, a custom code can include a variety of informational features, including a company logo of other information positioned in the center 240 (FIG. 6A), the lower right hand corner 250 (FIG. 6B), or the bottom 260 (FIG. 6C) of the barcode (a QR code is shown here) to identify the specific implant manufacturer and/or implant system (i.e., total joint replacement and/or partial joint resurfacing system). The MDM may also customize the code to identify the product model or marketing/label name that was selected by the manufacturing and/or marketing/sales department. The MDM may include a photo of the implant or other tools or kits that it may represent. The MDM may alternatively choose to uniquely identify a medical facility and/or surgeon in the code by placing their hospital site number, a photo of the surgeon or staff, or any specific ID number assigned to them.

In FIG. 6D, the MDM may include a discretely placed barcode 270 in one or more locations along a logo, photo, letter or unique identifier height or width. The MDM may choose to place multiple barcodes in series for scanning purposes or to direct users to different systems within the MDM internal processes.

In various alternative embodiments, the MDM may choose to customize any of the 1D, 2D, or 3D codes described herein (as well as various combinations thereof) to give the MDM maximum flexibility for placement of the code. For instance, certain portions of an implant or other item that may accommodate an integrated code may be of an unusual shape, size, surface contour or finish. In other embodiments, various surfaces of an item may require little or no additional processing, and thus may be particularly well suited for acceptance of an integrated code, but again may be of an unusual shape, size or surface contour or finish. To accommodate such areas, one or more unique code designs and/or shapes may be developed to fit within the desired shape, size or surface contour or finish of the given item or item series (i.e., similar product lines having similar shapes and/or sizes).

If desired, a combination of any code type (including the use of one or more combinations of the same code or combinations of all codes) may allow the MDM to unique identify the best application with the barcode and implement an efficient system. Also, using a combination of any of the existing barcodes may allow the MDM to also have larger data storage capacity for the information the MDM wishes to read, store, or hard link to a website for a user or a surgeon. Moreover, the use of “combined” or hybrid codes (i.e., machine readable codes also having human readable portions, or various other combinations of codes) of a single implant could enable the inclusion of confidential information (i.e., patient name, surgical facility identification, etc.) in a format not immediately comprehendible to a viewer along with non-confidential information (i.e., product assembly identification and/or implant dimensional specifications) that is human-comprehendible. Such a system has the potential to include sufficient code data to enable the manufacture, processing, inspection, shipping and use of the implant or other product without requiring access or reference to a remote or additional database, with the device carrying all necessary data in confidential and/or non-confidential form (or combinations thereof) in one or more integrated codes formed into the product surface.

Use of Barcodes in Medical Device Manufacturer (MDM) Processes

Traditionally, MDMs track the distribution of their products through a lot number system. The lot numbers are generated from an automated system, and an employee or printer prints lot number on labels. The employee then records the lot number into an inventory management system, and places the label directly on the product and/or on packaging thereof. However, because this process often occurs quite late in the manufacturing process, a number of issues can arise, including the placement of incorrect labels on an item through “human error” as well as the opportunity for such labels to be misprinted, become defaced and/or separated from the packaging or part upon which they have been placed. Human error can encompass a wide variety of simple mistakes, such as employee transposition of numbers or letters, or the employee could have entered improper address information, resulting in erroneous use of a product or sending a wrong shipment to a hospital. Human error can also encompass intentional acts, such as an employee intentionally mismarking a product in some manner. Even where lot numbers or other indicia are applied directly to a product, such application typically occurs late in the manufacturing and finishing process.

The various systems and methods described herein include the tailoring, configuring and/or customization of 1D, 2D and/or 3D codes (hereinafter referred to as “barcodes”) with electronically readable data that may be directly applied to the product itself early in the design and/or manufacturing process, and used to identify the product, service or other transaction related to the product, perform multiple transactions with an MDM product lifecycle or product supply chain, and link or associate the barcode to the customers (i.e. surgeons, medical facility staff, users, shipping and receiving, QC personnel, person, entity, researcher, participant, etc.) to the MDM selected transactions, product or service.

FIG. 16 illustrates an exemplary embodiment of a patient-specific implant system 1300. System 1300 is an example of a patient-specific total knee arthroplasty system having a femoral component 1310, a tibial tray component 1320, a polymer bearing surface component 1330 and at least one patient-specific instrument 1340 (such as a “jig” commonly used in a patient-specific surgery.) Each component includes a unique QR Code that is fabricated into the device, codes 1350, 1360, 1370 and 1380 respectively. The QR code can be fabricated into the component during manufacture, e.g., by printing, machining or etching the QR code into a surface of the femoral and tibial component(s), which can be made, for example, of metal such as cobalt, the polymer bearing surface component 1330, and the of the instrument(s), which can be made of a polymer material. In the embodiment described, each QR Code is placed to ensure is does not interfere with the operation or function of the component during surgery. For example, the QR Codes 1350 and 1360 of the femoral and tibial components is located on the surfaces 1390 and 1400 respectively of the component that will engage a cut bone surface of the patient and that will be fixed using cement. This ensures that the rough three dimensional surface of this embodiment does not interfere with the articular surfaces of the implant system, such as the outer articular surface of the femoral component that may abrade the polymer bearing surface that forms part of the tibial implant during surgery. Similarly, code 1360, is placed on a surface of the keel 1400 of the tibial tray to avoid engagement of the tibial tray during any potential micro-motion of the bearing surface following assembly and implantation of the implant system. However, QR Code 1380 is included on outer surface 1410 of instrument 1340. This provides an open and smooth outer surface to make the code more accessible and easier to scan as well as ensures that the contours of the code do not interfere with the patient-specific surfaces of instrument 1340. However, other placements of the codes are possible to accommodate other objectives, such as the placement of the code 1370 on an outer side surface 1420 of the polymer bearing surface component 1330 to facilitate identification of the component after surgery. Other components can be similarly arranged, for example, a code can be placed on a side edge of a tibial tray.

Many combinations of such a system are possible, including, for example, additional instruments or components that are not patient specific having similar codes, as well as systems for other articular joints, such as a hip, shoulder, or ankle joint, and patient-specific systems for non-articular joints or even devices and systems that are not patient specific.

In another embodiment that can be included in combination with system 1300, a QR code is associated with, for example by printing, with any documentation associated with the device, such as a label required pursuant to regulations, an illustration of the patient's anatomy and/or device used for planning purposes (such as the iView planning illustrations manufactured by ConforMIS, Inc.), a computer generated illustration, video or simulation. Such codes can be combined alone or with components of a physical implant system to denote patient information as well as uniquely identify particular components in the system and associate them with a particular patient and/or surgery. Such codes can be used together to assist in the design process, for example, but uniquely identifying patient anatomy, medical imaging data, computer aided design models, trial implants, bone models, and other items. Such codes can be used together to assist in the manufacturing process, for example, by providing a manually or automatically scannable code to ensure the proper identity of individual components of a system, to ensure and assist in the proper and accurate inspection of individual components (such as manual and automated inspections), to ensure and assist in the complete and accurate assembly and delivery of devices and systems, and to ensure and assist in the complete and proper set up, examination, and use of such devices and systems during surgery.

Additionally, such codes can be used in some embodiments to transfer information of personal health information (PHI) or other sensitive and/or protected data in a deidentified format. For example, a QR code can be electronically generated as both a visual indicator that can be scanned and/or as a uniform resource locator that links the code to a secured web site. Thus, for example, a doctor, hospital or sales representative can receive information related to a patient-specific device or system in a graphically coded form in printed, electronic or other form, and can retrieve PHI or other sensitive or protected information over a secure network in compliance with the applicable laws of a state or country. Such information can include access to information associated with the device or system, for example, surgical planning data, manufacturing data, design information, patient information, medical images, electronic models.

In another embodiment, the MDM may design an integrated code scanning system that may include multiple scanning devices for reading identification numbers or lot numbers programed into any type of 1D, 2D or 3D codes that utilizes codes that are physically permanently integrated within the design of various implants, tools or kits provided for surgery to prevent misidentification, misassembly, mislabeling and/or erroneous shipment of implants.

FIGS. 7A through 7C illustrate one exemplary top level flowchart of one embodiment of a code implementation system. The process may include a unique barcode system designed to link customers to a patient-specific implant ordering process and patient-specific case database 280. The flowchart of FIG. 7 may include fewer steps than illustrated, it may combine several of the steps in FIG. 7, or may expand certain steps in FIG. 7 into additional sub steps. In various alternative embodiments, other processes including non-patient-specific implant systems can incorporate features of the embodiments described herein, with varying degrees of utility.

The design of a patient-specific implant and associated tools and surgical techniques can introduce a number of unique and independent design and manufacturing step(s) in the development process for a surgical implant. The creation of a patient-specific product typically includes a variety of activities prior to the conceptual design and manufacturing of the specific product(s). Initially, a patient targeted for treatment is identified, and the “customer” (i.e., a surgeon) may conduct a pre-operative workup 290 of the patient that may include a variety of conventional 2D, 3D (or combinations thereof) imaging techniques that are used to identify relevant patient anatomy, including the characterization of thickness, size, area, volume, width, perimeter and/or surface contours of the patient's diseased and/or damaged anatomy and/or joints. Imaging techniques may be desirable to diagnose 300 the joint disease, and recreate natural or substantially similar natural surfaces and/or electronic image data thereof, facilitating the design and/or derivation of the specific product assembly to repair or replace the joint during surgery. Once a patient has been identified and relevant anatomical information obtained in some manner, the patient anatomical image data is typically sent to an implant manufacturer and/or designer. If the customer has previously been identified in the MDM system, the customer may manually submit the drawings to order product 330 to the MDM for evaluation for computer aided product design 340 or similar tools to create a 3D image representation of the product. However, in an alternative embodiment, if the customer has not been identified, the customer may request a unique patient-specific identification barcode 310 (UIBC) to order product and submit a pending product list order ticket (PLOT) 330 to computer aided product design 340.

Upon receipt of the patient's anatomical data, a UIBC or other code can be assigned to the data (if not already assigned by the surgeon or MDM) and electronically embedded therein, if desired. Appropriate design and modeling steps for creation and/or design of the patient-specific implant can be accomplished, and the resulting product design is sent to be manufactured using one or a combination of techniques, such as casting, machining, stamping, sintered laser metal (SLM), or steriolithography (SLA rapid prototyping), as well as many other techniques known in the industry.

Desirably, a UIBC will be associated with each component of the patient-specific implant (and associated tools and procedures) prior to initial implant manufacture, and depending upon the selected manufacturing process, the UIBC may be integrated into the initial manufacture of the item (i.e., programmed into the SLM manufacturing machinery) or the UIBC could be integrated into the component immediately upon completion of initial manufacturing processes (i.e., the UIBC is stamped, etched, machined and/or otherwise incorporated into the component). Integration of the UIBC into the component at this early stage significantly reduces the potential for accidental/intentional mislabeling of the component at later stages of the process, and also reduces the opportunity for selecting an incorrect implant for further processing, or using inappropriate specifications.

In various embodiments, the computer aided product design 340 personnel may identify the product for inventory management purposes using the UIBC, and this may include using the already assigned UIBC provided to the customer 350 or assigning an independent UIBC 350. In one embodiment, the computer aided product design 340 may include manufacturing instructions that embed the UIBC 360 within the product during manufacturing, or alternatively instructions to identify the product with the UIBC (which may include embedding the UIBC therein) after manufacturing. Various embodiments may still require confirmation of the designed product with the product list order ticket (PLOT) 380 prior to manufacturing and/or after it has been returned from manufacturing.

In various embodiments, a first UIBC may be embedded in a product to identify the product (i.e., an implant blank having a UIBC common to all pre-manufactured implant blanks previously stockpiled for later use) and subsequent processing of the blank may include removal the first UIBC and integration of a second UIBC in the processed product (i.e., a patient-specific UIBC identifying a specific patient-specific design created using the standard blank) to allow subsequent identification of the specific product later in the manufacturing and distribution chain.

After a product has been manufactured, processed and/or finished, quality control (QC) inspection 390 of the product may be performed to ensure that the design requirements have been met. In some embodiments, the product may be ready for shipping to the customer, or the product may have to be presented to manufacturing and/or assembly operations 400 for further refinement and/or assembly. Manufacturing operations 400 may conduct a variety of processes to produce the final resulting product, which may include assembler training verification 410 for the product to be assembled, and assurance that the proper tools, fixtures, components, and/or assemblies 430 are completed according to specified tolerances and properly documented in the inventory management system. Further refining or assembly may produce the resulting manufactured product 460 that will undergo a series of QC assembly inspections 440, inventory identification for inventory management and traceability 450, and possibly update the device master record (DMR) 480.

The verified or validated final resulting manufactured product 460 can be sent to the shipping and receiving department where the manufactured product 460 will be prepared for packaging, labeling and/or shipping 470 to the customer. The employee of the MDM may take the product and print shipping and lot number labels based on the order presented to them, or if a code system is in place, they may scan the code embedded in the product to print automated shipping labels. The employees can finalize the DMR 480 with the last data entry of the lot numbers or other identifying indicia of the product(s) being shipped, and any other notes they wish to enter. The manufactured product 460 will arrive at the medical facility of the customer 490, and the medical facility staff may either manually check the shipping documents to verify that the manufactured product 460 was received, or the medical facility staff may scan the available code(s) placed on the package or embedded in the product 500.

If the medical facility staff approve receipt of the manufactured product 460, the customer 490 may proceed with patient implantation 550 of the product(s). In one embodiment, the customer may be authorized 510 to access patient case data and any product alerts 520 prior to implantation if they want to confirm or assess their surgical approach. Once implantation has begun, the customer, the medical facility staff or MDM employees may be able to log the lot numbers or other identifying indicia of the products being implanted in a variety of ways, such as manually logging the product lot numbers on a medical facility provided form for the form to be stored with the patient history files, the MDM may provide peel able labels that the medical facility staff may place on medical facility provided forms, or if a barcode system is in place, the medical facility staff may scan each product being implanted for electronic storage in patient case data 280 or in the medical facility patient history system. The customer may also have recorded additional perioperative data 530 in the form of manual notes, audio, video or images that may be stored in a conventional patient history file, or in alternative embodiment, the barcodes can be scanned to upload and submit additional perioperative data with associated UIBC 540.

FIG. 8 illustrates a flowchart of one alternative embodiment of an integrated product code system that uses an automated barcode system to create a patient-specific product inventory management database system that further facilitates customer participation. In this embodiment, the product inventory management system can include a variety of processes or systems that can manage an inventory of patient-specific product through the MDM supply chain that will be implanted in patients. However, one skilled in the art will recognize that the product inventory management system is not limited to medical implants, and may be used for other nonmedical applications.

As shown in FIG. 8, the product inventory management system can be designed to include a customer computer network system and a product inventory management which may communicate with each other through the internet or other remote connection. The customer computer network system may include at one or more of the following: (1) a barcode system; (2) a computer which may be a desktop computer, a laptop computer, a tablet computer, smartphone or a mobile computer scanning device; (3) an independent scanning barcode device(s); and (4) software to interface with the customer computer network system, product inventory management system, and the scanning barcode device.

The product inventory management system (PIMS) can comprise a database, multiple computers, or one or more servers which store information and execute software for managing inventories of materials, components, parts or kit pieces that will be shipped and used by the customer in performing surgical procedures. The PIMS may include a customer authentication module, a product ordering module, a patient case data module, a computer aided design module, a product usage module, a training verification module, a shipping, receiving and labeling module, and a tracking module.

In one exemplary embodiment, the MDM manufacturing the patient-specific product may design the PIMS to allow the customer to order patient specific product with the implementation of a barcode system. When a medical facility is interested in purchasing product from an MDM that manufactures patient-specific implants, the medical facility may have to acquire approval of the medical facility prior to “selling” or otherwise authorizing assignment of the product to the customer. The approval process may require the customer to undergo training in use of the customer computer network, or the MDM may decide to install a customer computer network system (or install relevant software on existing computer systems) at the medical facility. If desired, the MDM may assign the medical facility and/or the surgeon an automated unique identification barcode 560 number (UIBC), or the UIBC may be assigned on a case-by-case basis (or other basis as desired by the MDM). One serialized UIBC could be assigned to the medical facility and the surgeon where a medical facility may have multiple surgeons within the medical facility using the MDM's product(s). For example, if the UIBC number was “05001,” the “05” could identify the medical facility, and the “001” could identify the first surgeon to use the MDM's product. The next surgeon to purchase and use the MDM's product could be assigned “05002”. The UIBC 560 desirably allows the customer to communicate with the customer computer network system and the MDM product inventory management system (PIMS). Once the UIBC is assigned to the customer, the MDM may decide to provide the UIBC to the customer in a variety of electronic or physical forms, such as an identification card, a key fob, a SMS text message, an internet certificate, an email, a scannable keychain or key ring cards (i.e., smartcard), a necklace or lanyard, or a combination thereof. Also, the MDM may require a customer to provide a password for security purposes.

In a next step, a patient may be admitted to a medical facility 570 (or may simply be present for pre-operative medical imaging) and the customer may perform a variety of pre-operative tests 580 on the patient. The preoperative tests may include bloodwork, 2D and/or 3D images, a physical, compilation of written annotations, and an analysis and summary of the patient's medical history. The customer can diagnose the patient with a degenerative disease in the joints or any other disease, and recommend that the patient undergo a surgical procedure, such as a total or partial joint replacement surgery 590. Upon approval that the patient wishes to undergo such surgery (and possibly pending or after approval from the insurer or other payor that such surgery is authorized and/or sufficiently financed), the customer may scan his UIBC 600 to communicate with the customer computer network system and the customer computer network system can prompt him to enter his password to authenticate identity of the customer and the medical facility 610 (customer authentication module) to access the PIMS. The authentication process may confirm the identity of the person accessing the PIMS and whether the medical facility address has remained the same.

Once the customer has been confirmed, the customer may access the product ordering module. One embodiment of the product ordering module may have a drop down list 620 categorized by the type of partial replacement surgery, total replacement surgery, by disease state, by age, by dimensions, by a series of questions if the customer is unsure of the type of product, by product, or any other combination thereof. After the surgeon has selected the joint surgery type, the PIMS displays a pending product list order ticket (PLOT) for the selected surgery. This PLOT may display a variety of information, such as a detailed list of implants, components, tools, jigs, kits that may be used for the selected surgery, the medical facility address, the expected arrival of the product to help scheduling of the surgery, the assigned UIBC, the customer name, or other information to help identify the surgery and the product, or a combination thereof. The customer can review the PLOT to determine if adjustments are necessary 640 on the PLOT (i.e., certain pieces of the kit are not necessary because the medical facility already carries it in inventory, etc). If there are adjustments necessary 650, the PIMS may be designed to allow the customer to add, edit or delete their PLOT similar to an “a la-carte” menu.

The PIMS may request the customer to confirm the final PLOT prior to prompting them to upload the preoperative patient-specific case data 660, or such data may have been previously uploaded. Once the customer confirms the final PLOT, the PIMS may direct the customer to access the patient-specific case data module 660. The patient-specific case data module may require the customer to enter or upload the patient's case data into the patient-specific case data module. The patient specific case data module 660 may require the customer to also submit a transmittal checklist with the entered or uploaded data to allow the MDM employees to confirm that the data was entered and uploaded properly. Should a piece of information be missing, the MDM may program the PIMS to recognize that information has been missed, improperly uploaded or entered, or that such data was not received or was corrupted.

The next step could require that the customer transmits the PLOT 670 through a product inventory management system (PIMS) or other path in conjunction with uploaded and entered patient-case data. The PIMS may be programmed to notify the MDM's customer service department 680 of the pending PLOT that was recently transmitted. The MDM employee notification may take the form of an email, a text message, a mobile app programmed in a mobile phone for notification of the pending PLOT, an automatic voicemail, or simply popping up the next module on the computer interface. The MDM employee or the customer service department can access the product usage module, and may be capable of generating automated serialized UIBC's (or other indicia) associated with the customer UIBC 690 for each item on the pending PLOT. For example, if the customer is assigned a UIBC “05002,” each product on the pending PLOT that will be used during surgery could have an automatic generated barcode that could be serialized and associated with the customer UIBC, such as “123401.” The “123” may identify the complete assembly, and “401,” “402,” “403,” could identify sub-assemblies or pieces in the complete assembly or even unique components or pieces in a kit. As a result, the pending human readable string in a linear barcode may appear to resemble “05002 123401” with additional information being only in machine-readable form in the remainder of the UIBC. In another embodiment, the MDM may program a similar numerical code into a QR barcode system if it is preferred.

The MDM customer service employee can confirm the properly generated plot with serialized UICB's that are associated with the customer UICB, and whether all the proper patient case data was received. The MDM customer service employee can submit the final PLOT into the computer aided product design module 700. After the computer aided design module 700 confirms receipt, the product inventory management system (PIMS) could produce an automated confirmation to the customer 710 summarizing their order, the barcodes and serialized bar codes of all the product they will receive for surgery, an expected delivery date, confirmed customer address and contact information, balance paid or due, and any other information that would be helpful on such a notification. This notification can be delivered by any means that the customer selects, such as email, text, SMS, any mobile apps, etc.

FIG. 9 illustrates a flowchart of one alternative embodiment of an embedded code system that could be used in conjunction with computer aided product design 340 of patient-specific and/or patient-adapted implant components, tools, instruments and/or associated procedures. The design and manufacture of patient-specific implants desirably includes the computer aided product design 340 department as a key service provider in product design as this function designs and/or selects appropriate product rendered drawings particularized for each individual patient that are subsequently sent to the relevant manufacturer for fabrication. The MDM may program the code system to include a computer aided product design module that uses the submitted PLOTs and associated UIBC's from the customer service department 700 to effectuate and optimize code embedding during the manufacturing of a product or placed therein after the manufacturing of a product 720. The embedded code system, which may form part of the computer aided design module, can be programmed to recognize whether a product design permits the associated UIBC to be embedded during manufacturing 720. If desired, the MDM may position a human operator and/or decision maker in the decision loop to decide whether the UIBC incorporation is appropriate and enter relevant information into the computer aided design module.

If the embedded code system or the computer aided design department (CADD) employee recognizes that an associated UIBC may be embedded into the implant or other products during manufacturing, the CADD employee can create or generate relevant product drawings, and position or place the associated UIBC in an appropriate location on the design drawing. The CADD employee can forward the drawings to the relevant manufacturer to embed or otherwise “print” the associated UIBC into the product 740 in a 2D 1410 (see FIGS. 16 and 17) and/or a 3D code (see FIGS. 18 and 19). In one alternative embodiment, a MDM may find it desirable to have a patient-specific femoral implant manufactured by sintered laser metal (SLS) process, or other power-based additive process. This process uses a powder-based additive manufacturing technology. Typically, successive layers of a powder (e.g., polymer, metal, sand, or other material) are deposited and melted with a scanning laser, i.e., a carbon dioxide laser, to form a fully-dense 3D product. This process may easily facilitate the embedding of a 3D barcode into the surface, and/or subsurface (recessing and/or insetting) of the product. For example, FIG. 19 depicts an embodiment of a femoral implant 1400 that may have a 3D barcode 1410 recessed below 1430 the surface. In various other embodiments, other manufacturing processes may facilitate 3D embedding of the associated UIBC, such as products that may be molded, casted, machined or stamped, or any other manufacturing processes known in the industry.

In alternative embodiments where the product design and/or manufacturing processes do not allow the associated UIBC to be embedded during manufacturing, the manufacturing design drawing may be forwarded without the associated UIBC incorporated into the design. In such a case, it will be desirable to link or otherwise embed the UIBC into other portions of the drawing and/or design file, so as to facilitate later embedding of the appropriate UIBC. The drawings can be forwarded to the relevant manufacturer and the product could be embedded with the code after initial manufacture, or could be forwarded to the MDM or a 3^{rd} party vendor for embedding or printing the code 750 in association with instructions contained in the design drawings and/or design file. The associated UIBC may be placed onto a product in a variety ways, including laser printing, laser etching, mechanical embedding, embossing, silk screening, dot-peening, electrochemical etching, machining, and ink-jet printing or other technologies known in the industry. Desirably, the chosen embedding method will “sink” the code below at least the initial surface layer(s) of the product to a desired depth.

In one exemplary embodiment, the code may be laser marked or printing on the product (see FIG. 13). As shown in FIG. 13, the laser marking system consists of computer with drawing files 1170, a laser source 1180, the beam-shaping optics 1190, a beam-steering system 1200, and the marking surface 1210. The laser is a light amplifier generating a bright, collimated beam of light at a specific wavelength. This laser offers several performance and cost advantages, and produces excellent marking results. The laser beam is projected through two rotatable beam-deflecting mirrors mounted to high-speed, high-accuracy galvanometers that allows the laser beam to scan across the target-marking surface on both the X and Y axes to “draw” the desired marking image 1220 (see FIG. 14A). The lasers' accuracy allows construction of barcodes having marking line widths and other features of approximately “0.0035 in. to 0.004 in.,” or man-readable text characters as small as 0.040 in. The laser process desirably etches and melts or removes material from the surface of the implant to a desired depth, and desirably does not require additional labels, stencils, punches or auxiliary hardware to improve the barcode or the barcode appearance.

In various other embodiments, the readability of a code may be enhanced by altering features of the implant's surface or subsurface (recessing) composition proximate to the embedded code, such as by silk screening of a white ink block 1230 (see FIG. 14B) or other surface feature to function as a background or border to the barcode that can optimize readability, or by “filling” the barcode with a secondary material. Such techniques may be desirable when the background color of the product could be similar to the color of the barcode, the underlying contours or shape of the product could obscure the readability of the barcode, or the product may not necessarily be suitable for laser marking or other marking techniques, such as ceramic based products.

In another alternative embodiment, a dot-peening technique may be used to embed a code on the product. The dot-peening technique typically utilizes a mechanical striking action onto the product, similar to “punching” a point for drill bits. With dot-peening, a carbide or diamond-tipped stylus pneumatically or electromechanically strikes the material surface. Some situations may require preparing the surface before marking to make the result more legible. A reader or scanner may adjust lighting angles to enhance contrast between the indentations forming the symbol and the part surface. The method's success often depends on assuring adequate dot size and shape by following prescribed maintenance procedures on the marker and monitoring the stylus tip for excessive wear. FIGS. 15A and 15B illustrate a printed data matrix barcode in black and white 1240 (see FIG. 15A) that can also be dot-peened onto another surface 1250 (FIG. 15B).

In other alternative embodiments, electro-chemical etching (ECE) or Ink-Jet printing may be used to embed barcodes on products. ECE produces marks by oxidizing surface metal through a stencil. The marker sandwiches a stencil between the part surface and a pad soaked with electrolyte. A low-voltage current does the rest. ECE can work well with rounded surfaces and stress-sensitive parts, including jet engines, automobiles, and medical device components. In addition, Ink-jet printers could be used, and can function in a manner similar to PC surface printers. The ink jet machine precisely propels ink droplets to the part surface. The fluid of the ink evaporates, leaving the marks behind. Ink-jet marking may require preparing the part's surface in advance so that the mark will not degrade over time. Its advantages include fast marking for moving parts and very good contrast. If desired, various corrosive substances may be “printed” on the surface of the implant in this manner, which subsequently removes surface material to a limited of desired depth, thereby embedding the desired code with the surface in a similar manner.

It should be understood that the various methods described herein to embed, silk screen, print, etch, emboss, laser of otherwise apply a code onto a product may be used at any time during the process of manufacturing of a product, although incorporating such code into the product at an early stage of manufacturing is highly desirable. For example, FIG. 18 shows one embodiment of a femoral implant 1400 where the 3D barcode 1410 that may be positioned above 1420 the non-articulating surface. The MDM may decide to place the 3D barcode above the surface during early stages of manufacturing of the product and prior to any further manufacturing process steps to create the resulting implant. The 3D barcode may have a height above 1420 the surface that allows the MDM to further process the implant (i.e. implant polishing, sanding or machining) and leave a residual thickness where the barcode may still be scanned. The height 1420 may have a 5 mm height when manufactured, and further processing, such as polishing, may remove 3 mm, leaving the bar code with a 2 mm height for a readable and scannable code. The embodiments discussed herein should not be construed as expressly limiting the way the various techniques may be applied, as well as not limiting the time point in the designing, manufacturing, finishing, testing and shipping process that such codes can be embedded.

As shown in FIG. 9, one exemplary next step in a computer aided product design 340 process could include the finishing and/or inspection of the product after manufacture and processing, and receiving the product at the MDM location 760. Various QC inspections can be done to the product verifying the product dimensions, integrity, and appearance according to product specifications 760. Also, the MDM may also want to check the readability of the UIBC 770 and confirm that the product has been received and compare it to the PLOT generated for the specific customer. After all confirmations have been made, the MDM employee can scan the UIBC on the product and enter the final QC inspection data into the device master record module, and enter store the final product in the product usage module if further processing of the product is required 780. At this point, the MDM employee may decide 790 to take a photo of the product to assist with the identification of the product for manufacturing operations. If no photo is required or desired, such information is stored in the PIMS 800. However, if a photo is required or desired 820, the MDM employee could upload the digital photo into the product usage module for manufacturing operations and its respective manufacturing process instructions (MPI). Finally, the MDM employee can update the PLOT with the proper QC inspections results and photo, if required, and submit it to the product usage module for notification to manufacturing operations.

FIG. 10 illustrates a flowchart showing one alternative embodiment of an embedded code system that can be used in conjunction with manufacturing operations 400. Such a system can be used to track manufacturing operations more effectively and efficiently, and can include a training verification module and/or a product usage module. The PIMS can include a training verification module that can assign unique identifying barcode 830 (UIBC) for each assembler to ensure that each assembler has the proper training to assemble or further process the product. The assembler's UIBC may be provided in a key ring card, a necklace or lanyard with a card, a regular card, or any other physical and/or electronic repository (i.e., a cell phone) which may hold and/or store their UIBC for scanning purposes.

Once the updated PLOT has been received in manufacturing operations, the PLOT can be waiting in the manufacturing queue. An assembler can be notified of the PLOT 840 arrival by automatic viewing on a computer screen, an audible sound or any other communication means if the assemblers are not waiting in the clean room. The assembler will proceed to the appropriate cleanroom environment to begin the first step of further processing the product. The assembler can first scan his or her UIBC and/or the updated PLOT with associated UIBCs 850 to display the relevant manufacturing process instructions (MPI) for the first step and confirm whether the assembler has satisfied the prerequisite training. This additional process ensures that the assemblers have been properly trained and that products will be assembled properly with the highest quality and zero defects.

In one exemplary embodiment, each MPI or a set of MPIs may specify a prerequisite training sequence to be completed by each assembler before performing the instruction presented through the user interface of a workstation or computer device. The scanning of the assembler's UIBC can request and retrieve from the PIMS a training history 860 associated with an assembler from a training verification database that includes a set of training sequences performed by the assembler. In certain embodiments, a detailed history of the various skills amassed by each assembler can be kept or stored in a training database module. Some skills in the training database may be acquired when the assembler performs a training exercise while other skills in the training database may result when the assembler performs other assemblies and task. In some embodiments, each assembly instruction may check the training database to determine whether the assembler is trained to perform the particular MPI or task 870, and various embodiments contemplated herein may include systems that can automatically direct product towards or away from specific assemblers based on the assembler's specific training.

In one exemplary embodiment, a determination can be made whether the training history associated with the assembler includes the specified prerequisite training sequence 880. In the event the assembler already meets the specified prerequisite training sequence (880—Yes), some embodiments could authorize the assembler to perform the MPI displayed on the user interface and display the materials needed for the process 920. Alternatively, the assembler might be required to perform a prerequisite training sequence when the determination indicates that the assembler has not been trained with the prerequisite training sequence 880 (No). If this occurs, the assembler can be guided to a computer workstation 890 to perform the prerequisite training sequence before proceeding with the assembly instruction and further operations to assemble the product 900. Once the assembler performs the prerequisite training sequence, in certain embodiments, the assembler training history is updated in the training verification module in the PIMS 910.

After the assembler has been verified to satisfy the prerequisite training for the specific MPI, the PIMS may authorize and automatically display on a user interface the instructions of the MPI and the materials, parts or components needed to complete the MPI 920. The assembler may then collect the materials, parts, components or fixtures 930, which could be in visual or written format by the MPI, and could be organized system within the cleanroom, by packaged items, or by any other method the MDM may find feasible. If desired, all of the products, materials, components or fixtures might have a code or other indicia placed on the item, and the assembler could scan the product 930 and the updated PLOT to confirm the right parts were collected 940. The assembler may be sufficiently prepared to complete the MPI as required by the instructions 950, and potentially perform a QC inspection of the product to check for dimensions, appearance, or other characteristics that may affect its function 960. In other exemplary embodiments, the MDM may include programming or instructions to video or take photos of various items at specific times during the assembly to verify the assembly of the products and store it in the device master record module. If the MPI is performed and the product passes QC inspection 970 (yes), the product can be rescanned to update the completion MPI onto the PLOT 990. After this has been completed, the display interface can queue the assembler for the subsequent MPI 1000. In some embodiments, the MDM may decide to enter notifications of QC inspections that may have passed even though that they are on the high end or the low end of the tolerance product specification. These annotations may prove to be useful for a customer during implantation should they recognize a looser or tighter fit of the product in a product assembly or in a patient.

FIG. 11 depicts a flowchart of an exemplary process where a QC inspection was not approved 970 (no), and the assembler decides what process to implement next 980. The assembler could query the system or other relevant data sources to determine whether a 2^{nd} back-up product, material, component or part exists 1010, or may submit additional queries in an attempt to determine next steps. If a 2^{nd} back-up product exists 1010 (yes), then the assembler may repeat the manufacturing operations indicated in FIG. 10 on the next product. Alternatively, if no 2^{nd} back-up product exists 1010 (no), then the assembler may decide to follow additional instructions and/or protocols to decide whether the product can be used “as-is,” whether it can be modified for use, whether the current product design can be utilized with subsequent changes to the associated surgical tool designs and/or changes to the surgical procedure, or whether an appropriate implant blank 1020 or another product can be designed, modified and/or manufactured in subsequent computer aided product design steps, such as those shown in FIG. 9. If it is possible or necessary to use an implant blank 1020, then the display interface can potentially prompt the assembler or suggest to the assembler which size of implant blank may be necessary to complete the MPI 1020 and what would resemble the closest in dimensions to the resulting patient-specific implant. The assembler can scan the implant blank 1030 (if the blank includes appropriate indicia, as described herein) to confirm that the right implant blank was collected and the product usage will be stored. The implant blank can be prepared to move onto the remaining manufacturing operations as shown in FIG. 10 to produce the final resulting product, and the current unacceptable implant or other product can be scrapped or otherwise disposed of.

In the various embodiments described herein, the use of embedded codes can facilitate the documentation of products, materials, components and/or parts designed, selected, manufactured, finished, shipped, used and/or consumed during the manufacturing operations, and this information can be properly documented in the PIMS using the product usage module. The product usage module can thus accurately track consumed product and product and equipment usage (i.e., for calibration requirements and/or wear calculation) to satisfy various requirements, including strict traceability guidelines mandated by various federal and/or state authorities.

FIG. 12 illustrates a flowchart of another alternative embodiment of an embedded code system that can facilitate the final product shipment to a customer 490. In this embodiment, manufacturing operations 400 can confirm and update the final PLOT for the product, which can include the proper shipping/labeling for product packaging (see FIG. 1—460 and 470). The shipping/receiving department employees can receive notification that the PLOT is ready for shipment. The shipping/receiving department employees can scan the final product 1040 into the product usage module of the PIMS to indicate that these products may be consumed by the customer and potentially tracked by the MDM. The shipping/receiving department employee could also scan the final PLOT to allow the system to confirm the manually scanned product with the listed product on the PLOT 1050. If the items are confirmed and match the PLOT 1060, the shipping/receiving and labeling module could print a sticker label to place on the box that has the customer associated barcode and other relevant address data printed on it. In some embodiments, both the barcode, human readable string, and the customer contact information may be printed on the label for any 3^{rd} party shipping service may allow.

Once the product has been prepared for shipment, a 3^{rd} party shipper can pick up the package, and the 3^{rd} party could potentially utilize a code scanner to confirm receipt. Products can then be shipped to the customer 1070. Once received, the customer could scan the barcode placed on the label and/or scan the code directly on the implant (where visible) to confirm receipt of the proper product, or the MDM may desire that the customer open the package and scan each barcode on each item 1080, and confirm it with the customer's summary PLOT 710 as shown in FIG. 7.

In another exemplary embodiment, the customer may wait to scan or verify product identity immediately prior to or during the surgical procedure, or it may be desirous to maintain sterility of such products until ready for implantation. The customer may choose to open each package in the operating room and scan each product barcode in the package to confirm that requested items match the PLOT 1080. The scanning process may also require that the customer scan his customer UIBC 1090 to hard link them to their customer workstation or a specific MDM website for patient case data access and authentication 1100. After the customer enters their specific password, the customer may have direct access to any previously uploaded patient case data, images, annotations, photos, notes, etc., to help him detail and/or follow a desired surgical strategy. The system may also provide the customer with access to some portions of the device master record module that stores specific results of QC inspections and notifies or alerts the customer to whether there are tolerances that may concern him or her during surgery.

In various embodiments, the PIMS may prompt the customer and query whether the customer wishes to provide additional perioperative patient case data during surgery 1110. The customer computer network may be linked to the MDM PIMS and provide simultaneous recording, video, photos, notes where indicated during surgery. The customer may be provided with an option after surgery to authorize storage of the information recorded during the surgery into the patient case data module 1120. Alternatively, the customer may decide to upload surgical information at a later time into the system by simply scanning and using the drop down list of patients that the customer has treated 1120. After all information has been entered, uploaded or stored, reviewed, edited or deleted, the customer or customer staff may transmit the final patient case data to the MDM product inventory management system (PIMS) 1130. The PIMS may notify the customer service department employee 1140 that there is pending patient case data 1140 waiting for MDM confirmation. The customer service department employee can confirm with the transmittal form list to ensure all information has been received. The PIMS can generate an automated notification 1140 that the pending patient case data has been received and could be confirmed in a few days or some other time period. The customer service department employee can process the patient case data and send final confirmed receipt of all information transmitted to MDM to be stored in the patient case data module 1160. The surgeon may close the patient file as implantation complete 550, and the MDM PIMS could keep accurate automated records of the product used within the patient, and any other detailed information that the customer wishes to update in the long-term care of the patient and/or for follow up by the treating physician and/or by any other subsequent medical professional.

Remote and Minimally-Invasive Use of Embedded Codes

Embodiments of the devices and methods disclosed may include the employment of codes readable by a variety of methods and techniques, including optical, physical, electronic and/or other sensors. Where a product has been implanted into a patient, a means for subsequent scanning and identification of the product at a later date may be desirable, such as where the patient may be undergoing further surgical procedures.

In various embodiments described herein, the use of RF or other electronic code systems may be particularly advantageous, in that such systems may permit remote scanning of imbedded codes, including the remote scanning (from outside the body) of devices located within a patient's body. Such systems may have the added advantage of being capable of scanning a product from any angle or orientation during the manufacturing, finishing and/or shipping of the product, and such RF codes can potentially be incorporated and/or implanted into various internal features of the product.

Depending upon the embedded code system utilized, information about implant characteristics and/or other features could be identified in a variety of ways through non-invasive and/or minimally-invasive techniques. For example, if a code included information that could be discerned remotely, such as through MRI or x-ray visualization, then such information might be read using such equipment. Similarly, optical codes that are placed on viewable locations of an implant (i.e., into outer or joint-facing structures of the implant not obscured by bone or surgical adhesives) could potentially be accessed using minimally-invasive techniques (i.e., endoscopic access), and the code location debrided and/or cleaned (if necessary using saline or other cleaning techniques) and scanned using standard or specialized equipment.

### Additional Embodiments

The embodiments discussed in this specification are exemplary, and many additional embodiments not discussed in this specification are possible. The foregoing embodiments are therefore to be considered illustrative, and are not intended to limit the scope of the specification.

1. A method of incorporating a scannable code on a medical product, comprising:
selecting a medical product;
obtaining a scannable code;
identifying at least one location on a surface of the medical product suitable for integrating the scannable code within the identified location; and
incorporating the scannable code into the medical product, such that at least a portion of the scannable code extends below the surface of the medical product.

2. The method of claim 1 wherein the step of incorporating the scannable code into the medical product comprises incorporating the scannable code into the medical product such that at least a portion of the scannable code is embedded below the surface of the medical product.

3. The method of claim 1 wherein the step of incorporating the scannable code into the medical product comprises incorporating the scannable code into the medical product such that at least a portion of the scannable code is recessed below the surface of the medical product.

4. The method of claim 1 wherein the scannable code is a one-dimensional code.

5. The method of claim 1 wherein the scannable code is a two-dimensional code.

6. The method of claim 1 wherein the scannable code is a three-dimensional code.

7. The method of claim 6 wherein the three-dimensional code is a three-dimensional QR code.

8. A method of incorporating a scannable code on a medical product, comprising:
selecting a medical product;
obtaining a scannable code;
identifying at least one location on a surface of the medical product suitable for integrating the scannable code within the identified location; and
incorporating the scannable code into the medical product, such that at least a portion of the scannable code extends above the surface of the medical product.

9. The method of claim 8 wherein the scannable code is a one-dimensional code.

10. The method of claim 8 wherein the scannable code is a two-dimensional code.

11. The method of claim 8 wherein the scannable code is a three-dimensional code.

12. The method of claim 11 wherein the scannable code is a three-dimensional QR code.

13. The method of claim 11 wherein the three-dimensional code is a three-dimensional matrix code.

14. A method of manufacturing a patient-specific medical product for treatment of a patient, comprising:
receiving patient-specific data;
designing at least one patient-specific feature of the medical product from the patient-specific data;
generating an electronic design drawing representing the medical product including the at least one patient-specific feature and including at least one surface;
obtaining a scannable code unique to the patient;
modifying the electronic design drawing to incorporate the scannable code into the surface; and
manufacturing the medical product using the modified electronic design drawing to create the medical product having the scannable code incorporated into the surface.

15. The method of claim 14 wherein the step of manufacturing the medical product comprises manufacturing the medical product by additive manufacturing using the modified electronic design drawing to create the medical product having the scannable code incorporated into the surface.

16. The method of claim 14 wherein the step of manufacturing the medical product comprises manufacturing the medical product by casting manufacturing using the modified electronic design drawing to create the medical product having the scannable code incorporated into the surface.

17. The method of claim 14 wherein the step of manufacturing the medical product comprises manufacturing the medical product by CNC machining using the modified electronic design drawing to create the medical product having the scannable code incorporated into the surface.

18. The method of claim 14 wherein the scannable code is a three-dimensional code.

19. The method of claim 14 wherein the scannable code is a three-dimensional QR code.

20. The method of claim 14 wherein the at least one patient-specific feature comprises a patient-specific surface.
